(19) United States
(12) Patent Application Publication
(10) Pub. No.: US 2016/0116892 A1
(43) Pub. Date: Apr. 28, 2016

(54) METHOD AND SYSTEM OF CAUSE ANALYSIS AND CORRECTION FOR MANUFACTURING DATA

(71) Applicant: INDUSTRIAL TECHNOLOGY RESEARCH INSTITUTE, Hsinchu (TW)

(72) Inventors: Kuang-Hung CHENG, Tainan City (TW); Chi-Chun HSIA, Kaohsiung City (TW); Shun-Chieh LIN, Tainan City (TW); Huan-Wen TSAI, Hsinchu City (TW)

(73) Assignee: INDUSTRIAL TECHNOLOGY RESEARCH INSTITUTE, Hsinchu (TW)

(21) Appl. No.: 14/578,898

(22) Filed: Dec. 22, 2014

(30) Foreign Application Priority Data
Oct. 22, 2014 (TW) 103136491

(51) Int. Cl. G05B 19/048; G01M 99/00

(52) U.S. Cl. CPC G05B 19/048; G01M 99/008; G05B 2219/24015

(57) ABSTRACT

A method and a system of cause analysis and correction for manufacturing data comprises: based on an plurality of historic manufacturing data, establishing abnormal classification rules and normal classification rules; comparing a current manufacturing data to the abnormal classification rules to identify a matching abnormal rule with the manufacturing data and an abnormal class thereof; comparing the current manufacturing data to the normal classification rules to determine a correcting rule and determine one or more correcting values of at least one of a plurality of manufacturing parameters; extracting abnormal features from the historic manufacturing data having the same condition as that of the manufacturing data, and extracting normal features from the historic manufacturing data matching the correcting rule; and based on the abnormal and the normal features, evaluating the cause contribution of the plurality of manufacturing parameters corresponding to the manufacturing data.

### CROSS-REFERENCE TO RELATED APPLICATION

The present application is based on, and claims priority from, Taiwan Application No. 103136491 filed Oct. 22, 2014, the disclosure of which is hereby incorporated by reference herein in its entirety.

### TECHNICAL FIELD

The technical field generally relates to a method and a system of cause analysis and correction for manufacturing data.

### BACKGROUND

The process of manufacturing raw materials into a product is called manufacturing process (or simply called process). In a manufacturing process, begin from raw material being fed to the production equipment, various treatments are performed at different manufacturing phases in a chronological order, and sensing signals that have been treated of the current manufacturing phase of the manufacturing process are stored. As in the example of a continuous casting manufacturing process in a steel plant, when molten steel is processed from the converter to the ladle, the composition of the molten steel is recorded. When the molten steel, hereafter called WIP (Work In Process) flows through the tundish and the mold, the mold level, the casting powder type, argon flow and the argon pressure force are recorded, then the WIP enters a secondary cooling zone, the current secondary cold water pressure and the current secondary cold water volume are recorded; and finally enters a straightening zone, the current temperature of the WIP is recorded. A final phase is proceeded for cutting the WIP into pieces of slab by a flame cutting machine, and the quality inspection result is recorded. Therefore for every piece of slab, records of manufacturing parameters such as the molten steel compositions, the secondary cold water pressure, the casting powder types and others, and quality check corresponding to the slab can be obtained. The formation of these records correspond to a manufacturing data of the slab. Even for a slab of tens of meters, each short segment (such as 10 cm) corresponds to records of sensing values and the result of quality check of passing each phase of the manufacturing process, thereby constitutes a single manufacturing data.

As technologies advance, more and more fine diverse products are manufactured. Accordingly manufacturing processes are increasingly complex, more and more manufacturing parameters should be able to be adjusted. Also in the manufacturing environment, there are many factors causing variation of manufacturing conditions, such as daily temperature and humidity, and other environmental factors. For machinery equipment after a long period of operation, drift will occur due to factors such as physical and chemical properties, source and composition of raw materials, operator proficiency and experience, etc. These factors increase the difficulty of maintaining stable manufacturing conditions. When unstable manufacturing conditions or manufacturing variation occurs, a manufacturing process will result in an abnormal production of the product.

Over the years, the engineering staff on the manufacturing site try to find out as soon as possible the abnormal causes of the product to adjust the manufacturing process to restore the normal production. The abnormal cause analysis on the manufacturing site usually relies on manual analyzing manufacturing records, such as process control parameters, measurement results, or various human operation records, such as working records, operation records, etc. to identify important manufacturing parameters that cause the abnormality. This approach relies heavily on the experience of senior staff. When the manufacturing conditions are increasingly complex, even the senior staff also takes a long time to find out the causes; in the meantime also more defective products having been produced.

In general, important manufacturing factors include composition design and manufacturing conditions. The design goal of a cause analysis system is performing an automatic analysis on the manufacturing data to quickly find out abnormal cause parameters, providing an abnormal correction suggestion, and performing an immediate feedback for each abnormal case to assist immediate improvement. In general, an effective cause analysis system may shorten yield learning time and accelerate eliminating manufacturing abnormality, so as to increase productivity and reduce losses due to abnormality.

Techniques of existing cause analysis systems may be divided into two classes. One class is statistical cause analysis, and the other class is rule-based cause analysis. The statistical cause analysis technique analyzes historic data to establish statistical model, statistics amount and control limit, and monitors if the statistics amount exceeds the control limit. When the statistics amount exceeds the control limit, a statistical model is used to analyze important cause parameters. This class of statistical cause analysis techniques may be used to analyze the causes of a single manufacturing data and may further be used to calculate the cause contribution weights. The rule-based cause analysis technique establishes abnormal cause rules with historic data, and then summarizes abnormal rules to find out important cause parameters. The rule-based cause analysis technique may be used to analyze numerical and/or non-numeric data. And the rules bear the threshold value of abnormal parameter to act as a reference for the cause correcting strategy assistance.

There is a technique that uses an overall probability distribution of the cause parameters as a basis to provide the manufacturing recipe correction. There is a technique that establishes the abnormal detection and the classification structure of semiconductor manufacturing with statistic models, which uses all normal data to establish a multi-linear principal component analysis (MPCA) model, and performs clustering, wherein similar manufacturing parameters are classified into a same group. Then this technique takes abnormal data from a group of an abnormal set, transfers the abnormal data to a contribution map with a principal component analysis (PCA) model, to get causes with a large abnormal contribution, then establishes a decision tree for these causes to obtain rules of the decision tree, and uses these rules to perform an abnormal prediction and/or classification. There is a technique that divides data based on data features (width level) to establish principal component analysis models respectively, and monitors if a solid phase extraction (SPE) statistics amount exceeds the standard, and further elects important parameters that cause abnormality using the contribution map.

In the above and the existing cause analytical techniques, some techniques such as statistical analysis techniques are unable to analyze non-numerical data or parameters, and fail to provide complete anomaly correction suggestions. Some techniques such as rule-based analysis techniques lack of theoretical basis for analyzing the abnormality of single manufacturing data, and are unable to recommend appropriate correcting strategies. Therefore, how to design cause analysis techniques suitable for analyzing abnormal causes of single manufacturing data, providing appropriate correcting strategies and pointing out correcting values, and simultaneously analyzing numerical type/non-numeric type data, and able to provide the contribution weights of causes, is worthy of study and development.

### SUMMARY

The exemplary embodiments of the disclosure may provide a method and a system of cause analysis and correction for manufacturing data.

One exemplary embodiment relates to a method of cause analysis and correction for manufacturing data, adapted to a manufacturing process in a manufacturing system. This method comprises: based on a plurality of historic manufacturing data, establishing at least one abnormal classification rule and at least one normal classification rule, and storing the at least one abnormal classification rule and the at least one normal classification rule in a database storage device; comparing a current single manufacturing data with the at least one abnormal classification rule to identify at least one abnormal rule matching the current single manufacturing data and an abnormal class thereof, wherein the current single manufacturing data comprises a plurality of manufacturing parameters; comparing the current single manufacturing data with the at least one normal classification rule to determine a correcting rule, and determine one or more correcting values of at least one manufacturing parameter of the plurality of manufacturing parameters; extracting a plurality of abnormal features from the plurality of historic manufacturing data having a same condition as that of the current single manufacturing data, and extracting a plurality of normal features from the plurality of historic manufacturing data matching the correcting rule; and based on the plurality of abnormal features and the plurality of normal features, evaluating at least one abnormal cause contribution of the plurality of manufacturing parameters corresponding to the current single manufacturing data.

Another exemplary embodiment relates to a system of cause analysis and correction for manufacturing data, adapted to a manufacturing process in a manufacturing system. The system may comprise a classification rule generator module, an abnormal identification module, a correcting rule selection module, a class dependent feature generator module, and a parameter contribution evaluation module. The classification rule generator module establishes, based on a plurality of historic manufacturing data, at least one abnormal classification rule and at least one normal classification rule. The abnormal identification module compares a manufacturing data with the at least one abnormal classification rule to identify at least one abnormal rule matching the manufacturing data, and an abnormal class thereof. The correcting rule selection module compares the manufacturing data with the at least one normal classification rule to generate a plurality of correcting strategies and determine, a correcting rule, and determine one or more correcting values of at least one manufacturing parameter of a plurality of manufacturing parameters. The class dependent feature generator module extracts a plurality of abnormal features from the plurality of historic manufacturing data having a same condition as that of the manufacturing data, and extracts a plurality of normal features from the plurality of historic manufacturing data matching the correcting rule. The parameter contribution evaluation module, based on the plurality of abnormal features and the plurality of normal features, evaluates at least one abnormal cause contribution of the plurality of manufacturing parameters corresponding to the manufacturing data.

### BRIEF DESCRIPTION OF THE DRAWINGS

FIG. 1 defines and shows an exemplar of the manufacturing data, according to an exemplary embodiment of the disclosure.

FIG. 2 shows a schematic view illustrating a method and a system of cause analysis and correction for manufacturing data, wherein the method and the system are adapted to a manufacturing system, according to an exemplary embodiment of the disclosure.

FIG. 3 shows a method of cause analysis and correction for manufacturing data, according to an exemplary embodiment of the disclosure.

FIG. 4A shows an operation flow illustrating how to establish abnormal classification rules and normal classification rules by using a decision tree algorithm, based on a plurality of training data, according to an exemplary embodiment of the disclosure.

FIG. 4B shows an operation flow for sub-steps of each step shown in FIG. 4A, according to an exemplary embodiment of the disclosure.

FIG. 5A shows an exemplar of a decision tree established by following the operation flow of FIG. 4, according to an exemplary embodiment of the disclosure.

FIG. 5B shows corresponding classification rules of the decision tree in the FIG. 5A, according to an exemplary embodiment of the disclosure.

FIG. 6 shows an operation flow illustrating an optimal selection method for correcting strategy, according to an exemplary embodiment of the disclosure.

FIG. 7 shows correcting strategies and corresponding correcting constraints of candidate correcting rules, and the cost calculation of the correcting strategies, according to an exemplary embodiment of the disclosure.

FIG. 8 shows a detailed operation flow of a bidirectional feature extraction method, according to exemplary embodiment of the disclosure.

FIG. 9 shows an operation flow for evaluating an abnormal cause contribution of a manufacturing parameter, according to the exemplary embodiment of the disclosure.

FIG. 10 shows a system of cause analysis and correction for manufacturing data, according to an exemplary embodiment of the disclosure.

### DETAILED DESCRIPTION OF THE DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

In the disclosure, a single manufacturing data means a collection of a variety of records of sensing or control signals and related operations of a same product, processed at different points in time sequentially. These records are hereinafter referred to as manufacturing parameters, and may further include the quality code of the product processed completely. Historic manufacturing data means including historic manufacturing data of each product of a plurality of produced products. Non-numerical data or parameters mean data or parameters that cannot be used for numerical computations, or data or parameters that no meaningful numerical encoding and computations can be performed on. A non-numerical data or parameter may be such as a raw material type of a manufacturing process or a place that raw materials come from, and so on. A numerical data or parameter means a data or parameter that can be used for numerical operations. A numerical data or parameter may be such as a pressure or temperature of a production equipment, etc. in a manufacturing environment. The results via numerical computations of two numerical data can be used to determine the relationship between the two numerical data.

Manufacturing site often has many constraints on the environment, equipment and so on, so that doctrinal manufacturing conditions fail to be achieved, therefore, these constraints will be taken into consideration during the actual adjustment for the manufacturing process. In the present disclosure, by considering limitations of a manufacturing environment, an equipment tolerance, and production costs, some operation for the parameter adjustment will be limited, such limitations usually called correcting constraints. These correcting constraints may be preset when the system is established, also may be gradually increased or modified in accordance with accumulated experiences of the manufacturing process, or changes of environments or products.

According to exemplary embodiments of the disclosure, a method and a system for cause analysis and correction are provided. This technology establishes abnormal classification rules and normal classification rules according to a plurality of historic manufacturing data; identifies at least one abnormal rule matching a current single manufacturing data, and decides a correcting rule and some parameter correcting values thereof, by comparing a current single manufacturing data with these rules; and extracts abnormal features and normal features from the plurality of historic manufacturing data, according to the at least one abnormal rule matching the current single manufacturing data and the correcting rule; then evaluates at least one abnormal cause contribution of the plurality of manufacturing parameters corresponding to the current single manufacturing data, by a comparing differences between the current single manufacturing data and normal features and abnormal features, respectively. The format of the correcting rule may be, for example, “Rₖ: Aₖ→C_{k′}”, where Rₖ is the correcting rule, Aₖ is a known condition, Cₖ is an estimation result, the correcting rule Rₖ represents the rule of “when Aₖ occurs, Cₖ occurs”.

In other words, this technique establishes bidirectional detection and judgment of manufacturing abnormalities. On one direction, it compares a current manufacturing process with known normal manufacturing processes to identify where the deviation is. On another direction, it compares the current manufacturing process with known abnormal manufacturing processes to identify similar features. In accordance with exemplary embodiments of the disclosure, this bidirectional detection and judgment of manufacturing abnormalities simultaneously takes these two directions into consideration, which includes, establishing bidirectional (abnormal and normal) classification rules, comparing a manufacturing data with these bidirectional classification rules respectively, determining at least one abnormal class of the manufacturing data, evaluating a correcting strategy, combining with a bidirectional feature extraction, and integrating bidirectional parameter contributions, thereby analyzing abnormal causes and a correcting method for each single manufacturing data. This upgrades the current abnormal cause analysis to a real time level of abnormal correcting decision assistance.

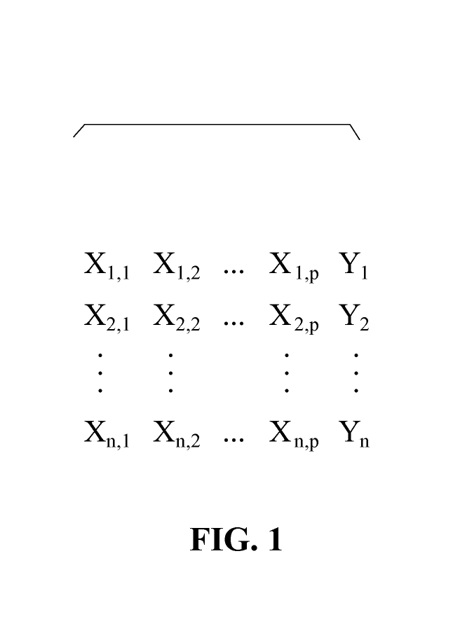

According to above definition of the present disclosure, for the historic manufacturing data, the current single manufacturing data, and each subsequent manufacturing data, any of the above mentioned manufacturing data may include one or more manufacturing parameters corresponding to the recorded manufacturing data for a product in a manufacturing process, and may further include a quality code of the product processed completely. FIG. 1 defines and shows an exemplar of the manufacturing data, according to an exemplary embodiment of the disclosure. In the exemplary embodiment of FIG. 1, there are a total of n manufacturing data, n is a positive integer greater than 1, wherein X_{k,j} represents the value of the j-th manufacturing parameter of the k-th manufacturing data, Yₖ represent the quality code of the k-th manufacturing data, k is a positive integer, and 1≦k≦n. That is, each manufacturing data comprises p manufacturing parameters and a quality code. For example, the first manufacturing data comprises p manufacturing parameters X_{1,1}, X_{1,2}, . . . X_{1,p}, p is a positive integer greater than 1, and a quality code Y₁; the k-th manufacturing data comprises p manufacturing parameters X_{k,1}, X_{k,2}, . . . X_{k,p}, and a quality code Yₖ. According to an exemplary embodiment of the present disclosure, the quality code Yₖ may also be a quality level.

These manufacturing parameters of each manufacturing data may comprise one or more setting values or control values for a plurality of manufacturing conditions in a manufacturing process. These manufacturing parameters may also comprise measured values or sensed values of one or more measuring devices set in a manufacturing field of the manufacturing process, such as the measured values or sensed values of an equipment and/or sensors. The quality code of each manufacturing data is an abnormal class of a plurality of abnormal classes, or a normal class represents no abnormal. The quality code of each manufacturing data may also be a code representing a quality level of a product, for example, a quality level A of a product, a quality level B of the product, . . . , a quality level E of the product. It may further define one or more quality levels correspond to one or more normal classes, for example, the quality level A and the quality level B correspond to a normal class N. Yet, it may further define one or more quality levels correspond to one or more abnormal classes, for example, the quality level C corresponds to an abnormal class D1, and both the quality level D and quality level E correspond to an abnormal class D2.

Take the manufacturing process in a continuous casting of a steel mill as an exemplar. For example, the k-th manufacturing data comprises five parameters, wherein X_{k,1} (secondary cold water pressure)=69; X_{k,2} (argon gas pressure)=107; X_{k,3} (argon gas flow rate)=44; X_{k,4} (powders species)=A; X_{k,5} (straightening zone temperature)=97. Thus the first manufacturing parameter X_{k,1} of the k-th manufacturing data represents the secondary cold water pressure, and the secondary cold water pressure is 69; the second manufacturing parameter X_{k,2} is the argon gas pressure, and the argon gas pressure is 107; and so forth, the fifth manufacturing parameter X_{k,5} is the straightening zone temperature, and the straightening zone temperature is 107. As for the quality code of the k-th manufacturing data, for example, when Yₖ=“D1”, it represents the corresponding quality code of the k-th manufacturing data is “abnormal class 1”, while Yₖ=“N”, it represents the corresponding quality code of the k-th manufacturing data is “no abnormal.”

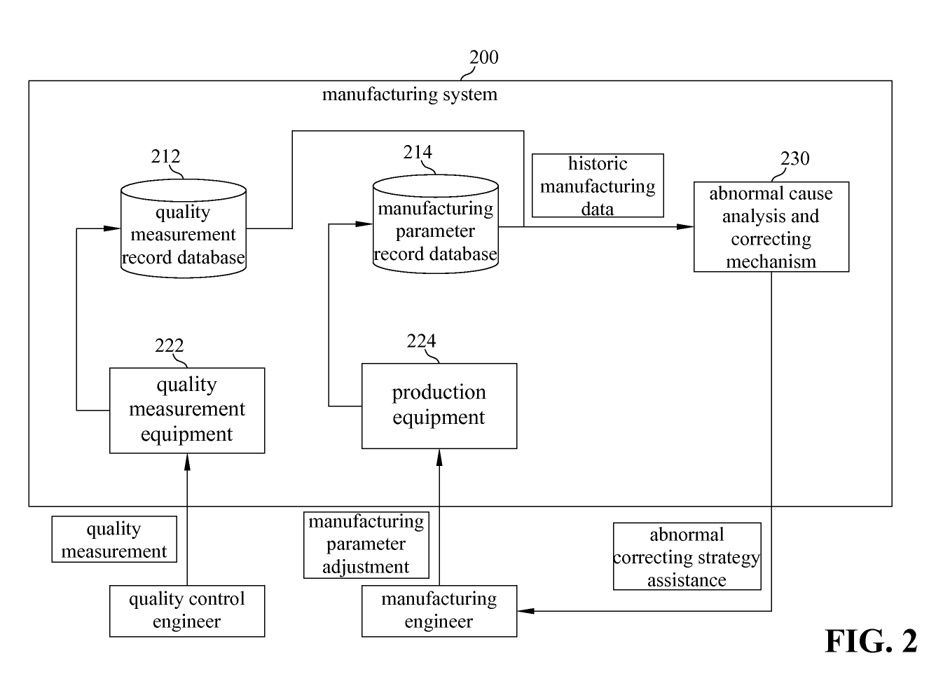

FIG. 2 shows a schematic view illustrating a method and a system of cause analysis and correction for manufacturing data, wherein the method and the system are adapted to a manufacturing system, according to an exemplary embodiment of the disclosure. Refer to the exemplary embodiment of FIG. 2, a manufacturing system 200 may be equipped with a quality measurement record database 212, a manufacturing parameter record database 214, a quality measurement device 222, and a production device 224. According to this exemplary embodiment, an abnormal cause analysis and correction mechanism 230 may obtain a plurality of historic manufacturing data from the quality measurements record database 212 and the manufacturing parameter record database 214; based on the plurality of historic manufacturing data, and it may establish abnormal classification rules and normal classification rules, whereby for a current manufacturing data, extract its abnormal features of an abnormal class and normal features matching a correcting rule, and these rules and features such as can be stored in a database storage device. The abnormal cause analysis and correcting mechanism 230 may further evaluate manufacturing parameters associated with the abnormal class and the contributions of these manufacturing parameters, thus providing abnormal correcting strategy assistance, even accordingly may in time assisting engineering staff on eliminating abnormality of manufacturing. For example, the obtained important manufacturing parameters and their contributions may assist professional engineers (such as manufacturing engineers, quality control engineers, etc.) on the manufacturing site to lock manufacturing parameters, to accelerate analysis of the relationship between these parameters and abnormal cause formation to help improving the manufacturing process.

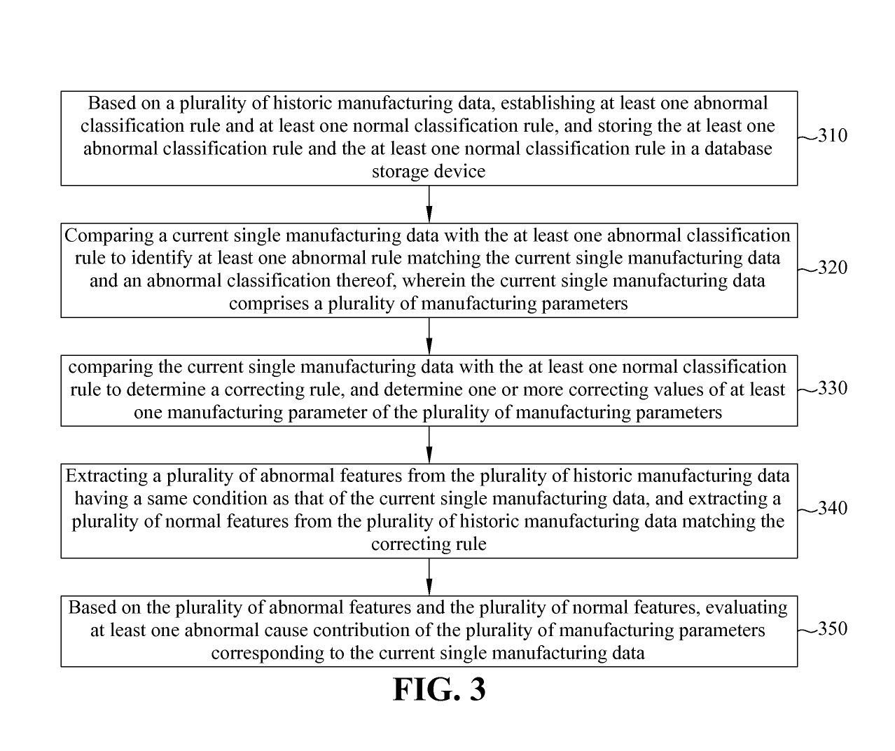

Accordingly, FIG. 3 shows a method of cause analysis and correction for manufacturing data, according to an exemplary embodiment of the disclosure. This method is adapted to a manufacturing process in a manufacturing system. Refer to FIG. 3, this method performs: based on a plurality of historic manufacturing data, establishing at least one abnormal classification rule and at least one normal classification rule, and storing the at least one abnormal classification rule and the at least one normal classification rule in a database storage device (step 310); comparing a current single manufacturing data with the at least one abnormal classification rule to identify at least one abnormal rule matching the current single manufacturing data and an abnormal classification thereof, wherein the current single manufacturing data comprises a plurality of manufacturing parameters (step 320); comparing the current single manufacturing data with the at least one normal classification rule to determine a correcting rule, and determine one or more correcting values of at least one manufacturing parameter of the plurality of manufacturing parameters (step 330); extracting a plurality of abnormal features from the plurality of historic manufacturing data having a same condition as that of the current single manufacturing data, and extracting a plurality of normal features from the plurality of historic manufacturing data matching the correcting rule (340); and based on the plurality of abnormal features and the plurality of normal features, evaluating at least one abnormal cause contribution of the plurality of manufacturing parameters corresponding to the current single manufacturing data (step 350). In the manufacturing process, for each subsequent manufacturing data, the above steps of establishing, comparing, extracting, and evaluating are performed.

In step 340, a plurality of abnormal features from the plurality of historic manufacturing data having the same condition, wherein said same condition may be a same quality code, or matching a same abnormal rule, according to an exemplary embodiment of the present disclosure. All the historic manufacturing data having the same condition as that of the single manufacturing data, for example, are all historic manufacturing data belong to the same abnormal class, or all historic manufacturing data matching the same abnormal rule as that of the single manufacturing data. In other words, while extracting abnormal features, not limited to extracting from all historic manufacturing data belong to this abnormal class, it may also extract from historic manufacturing data matching the same abnormal rule. According to an exemplary embodiment of the disclosure, basically this method of cause analysis and correction may be divided into model training (establishment) and online analysis. Step 310 to Step 350 are elastically exchangeable in order, which is described as following.

The model training (establishment) may include the feature extraction of steps 310 and 340; according to an exemplary embodiment of the disclosure, step 310 and step 340 may be performed after the historic data has been accumulated for a period of time; after establishing rules in step 310, corresponding feature extraction of each rule or class may be performed; the output result of step 310 and step 340 may also be stored in a database, respectively. How often model training (establishment) is performed may depend on the condition of actual implementation, usually the model training (establishment) do not need to be redone for each receiving of a new manufacturing data.

Online analysis may include the step 320, step 330, step 340 (based on a single manufacturing data received online, according to its compliance with the abnormal rules, correcting rule, the identified abnormal class, corresponding directly to the extracted features existed in the database), and step 350; these steps may analyze the causes contribution of the single manufacturing data by using existed models (including rules, features) in the database and a single manufacturing data received online.

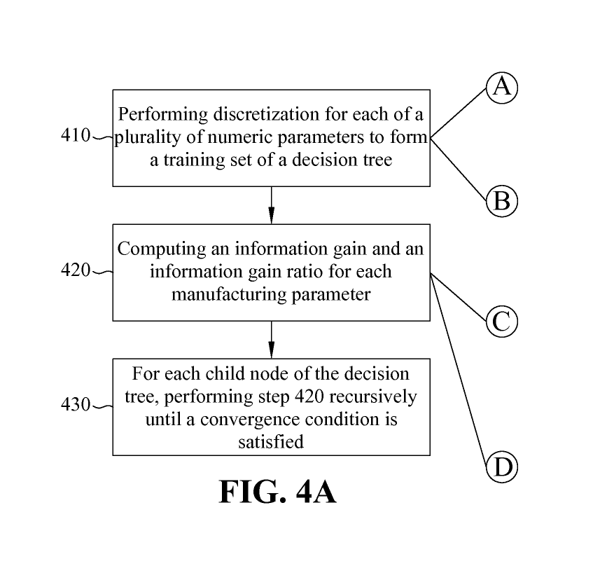

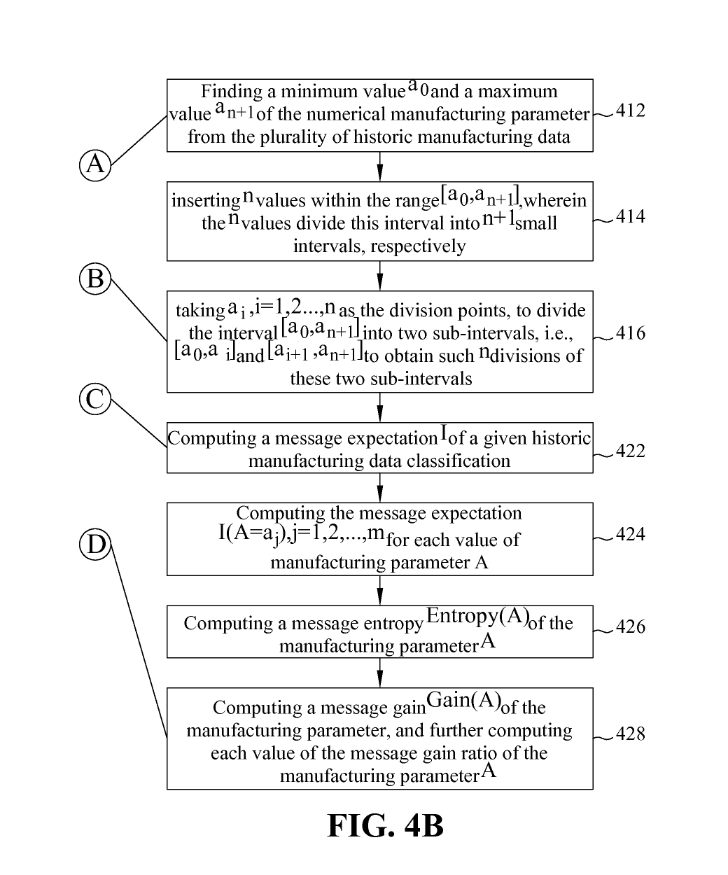

According to an exemplary embodiment of the disclosure, in step 310, the establishment of abnormal classification rules and normal classification rules may use statistical or data mining methods such as a decision tree algorithm, a correlation analysis algorithm and so on. FIG. 4 A shows an operation flow illustrating how to establish abnormal classification rules and normal classification rules by using a decision tree algorithm, based on a plurality of training data (historic manufacturing data), according to an exemplary embodiment of the disclosure. Wherein, a path from a root node to a leaf node may represent a classification rule. In the operation flow of FIG. 4A, firstly, discretization for each of a plurality of numeric parameters may be performed to form a training set of a decision tree (step 410), when there is no numerical parameter, this step is skipped. Then an information gain and an information gain ratio for each manufacturing parameter are computed (step 420), wherein a manufacturing parameter with the maximum information gain ratio may be selected as the decision attribute of the current node, and each possible value of the manufacturing parameter corresponding to a subset to generate a child node. For each child node of the decision tree, step 420 is performed recursively until a convergence condition is satisfied (step 430). When the data in a child node all belong to a same class, the convergence node is a leaf node. When all nodes fail to generate a child node other than a leaf node, construction of the decision tree is completed.

FIG. 4B shows an operation flow for sub-steps of each step shown in FIG. 4A, according to an exemplary embodiment of the disclosure. Step 410 may further include the following sub-steps: finding a minimum value a₀ and a maximum value aₙ₊₁ of the numerical manufacturing parameters from the plurality of historic manufacturing data (step 412); inserting n values within the range [a₀, aₙ₊₁], wherein the n values divide this interval into n+1 small intervals (step 414), respectively; and taking aᵢ, i=1, 2, . . . , n as the division points, to divide the interval [a₀, aₙ₊₁] into two sub-intervals, i.e., [a₀, aᵢ] and [aᵢ₊₁, aₙ₊₁] to obtain such n divisions of these two sub-intervals (step 416).

In step 420, calculating the information gain of the manufacturing parameter A may further include the following sub-steps 422, 424, 426, and 428. In sub-step 422, a message expectation I of a given historic manufacturing data classification is computed; For example, a given historic manufacturing data collection D is divided into k classes of quality codes, such as an abnormal 1, an abnormal 2, . . . , no abnormal, namely k sub-sets D₁, D₂, . . . Dₖ; d is a total number of data items in a historic manufacturing data set D, dᵢ is a number of data items in the subset Dᵢ; pᵢ=dᵢ/d,i=1, 2, . . . , k is the probability of a manufacturing data belonging to the class i, and so on, the message expectation of the historic manufacturing data set D is as followings:

I=−Σᵢ₌₁^{k}pᵢ log₂(pᵢ).

In other words, the message expectation represents the uncertainty of dividing the historic manufacturing data set D into k classes.

In sub-step 424, the message expectation I(A=aⱼ), j=1, 2, . . . , m for each value of manufacturing parameter A is computed, wherein the values of the manufacturing parameter A are a₁, a₂, . . . , aₘ, m≧2; For example, the manufacturing parameter A is the secondary cold pressure, m=50, a₁=61, a₂=62 . . . , a₅₀=110, dⱼ is the number of data items when A=aⱼ, d_{i,j} is the number of data items belonging to the subset Dᵢ when A=aⱼ, then when A=aⱼ, the probability of manufacturing data belonging to the class i is p_{i,j}=d_{i,j}/dⱼ, and

I(A=aⱼ)=−Σᵢ₌₁^{k}p_{i,j} log₂(p_{i,j}).

In sub-step 426, an entropy Entropy(A) of the manufacturing parameter A is computed as followings:

Entropy(A)=Σⱼ₌₁^{m}pⱼ·I(A=aⱼ).

Wherein pⱼ=dⱼ/d, and dⱼ is the number of data items when A=aⱼ.

In sub-step 428, an information gain Gain(A) of the manufacturing parameter A is computed as followings:

Gain(A)=Entropy(A)−I.

For a numeric manufacturing parameter, a corresponding classification information gain ratio with division points aᵢ, i=1, 2, . . . , n is computed, respectively, and a corresponding aᵢ of the maximum information gain ratio is selected as the division point of the numeric manufacturing parameter. For a non-numeric manufacturing parameter, information gain ratios corresponding to each value of the manufacturing parameter may be computed by the above formulas, while for a numerical manufacturing parameter, information gain ratios of n division points are required to be computed, respectively. If a manufacturing parameter with the maximum information gain ratio of a current node is a non-numeric parameter A when the value is aᵢ, then the decision attribute of the current node is the manufacturing parameter A. In the following, a set may be divided into two sub-sets, A=aᵢ and A≠aᵢ, respectively, to form two sub-nodes. If the manufacturing parameter with the maximum information gain ratio of the current node is a numeric parameter B with a division point bᵢ, then the decision attribute of the current node is the manufacturing parameter B. Yet in the following, a set is divided into two sub-sets, [b₀, bᵢ] and [bᵢ₊₁, bₙ₊₁], respectively, to form two sub-nodes.

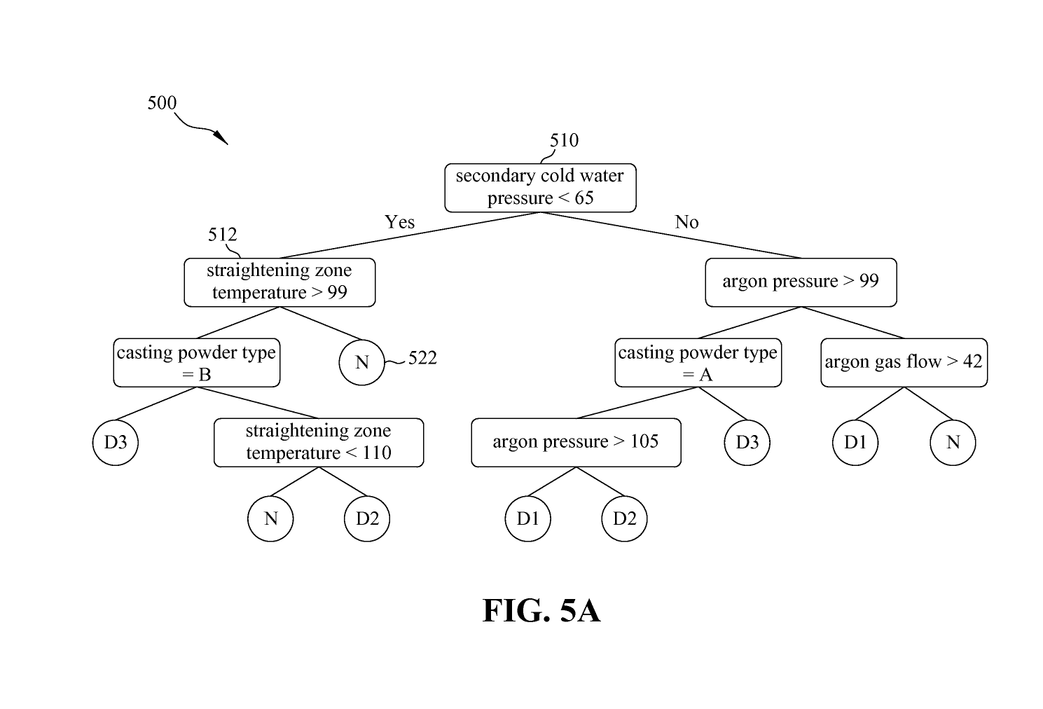

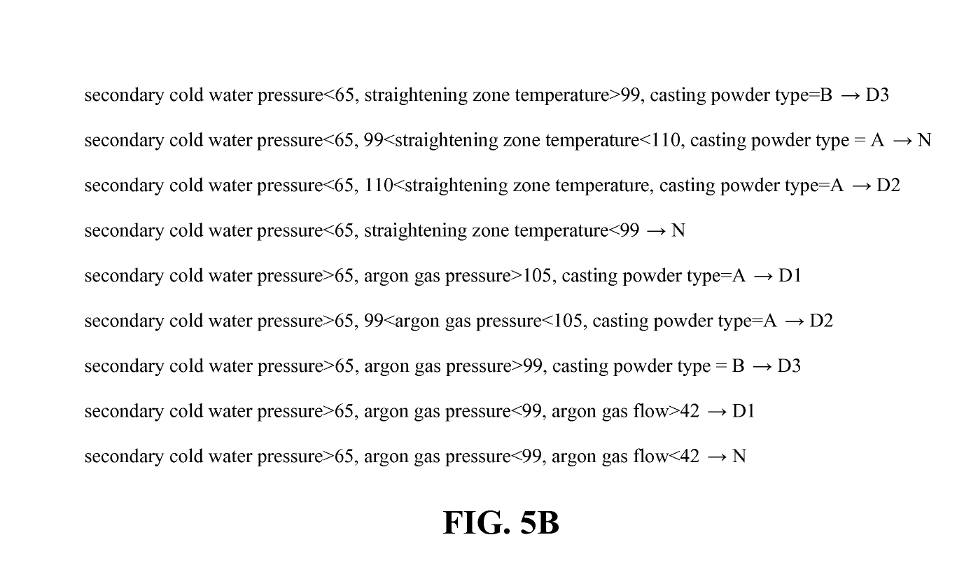

A plurality of historic manufacturing data of a continuous casting steel mill is taken as an exemplar of a plurality of training data. FIG. 5A shows an exemplar of a decision tree established by following the operation flow of FIG. 4, according to an exemplary embodiment of the disclosure. In a decision tree 500 of FIG. 5A, each non-leaf node is represented by a rectangular block, according to the classification conditions of a manufacturing parameter, for example, the classification condition of a non-leaf node 512 is “straightening zone temperature >99”. When each leaf node represents satisfying all classification conditions from a root node to the leaf node, the determined quality code is represented by a symbol within a circular area. For example, a leaf nodes 522 represents that when classification condition of a root node 510 (i.e., “secondary cold water pressure <65”) is satisfied, and classification condition of a node 512 (i.e., “straightening zone temperature >99”) is not satisfied, the determined quality code is “N”. Accordingly, each leaf node may represent a quality classification rule. For example, the leaf node 522 may represent a classification rule, namely, secondary cold water pressure <65, straightening zone temperature <99→N. FIG. 5 B shows corresponding classification rules of the decision tree in the FIG. 5A, according to an exemplary embodiment of the disclosure, wherein nine leaf nodes included in the decision tree 500 represent nine classification rules, and when a leaf node is “N”, it means that this leaf node represents a normal classification rule (or normal rule); when the leaf node is “D1” or “D2” or “D3”, it indicates that the leaf node represents an abnormal classification rule (or abnormal rule).

Following the exemplary embodiment of FIG. 5B, assuming that the current manufacturing data comprises five manufacturing parameters, wherein X_{k,1} (secondary cold water pressure)=69; X_{k,2} (argon gas pressure)=107; X_{k,3} (argon gas flow)=44; X_{k,4} (casting powder type)=A; X_{k,5} (straightening zone temperature)=97; then according to the step 320 of FIG. 3, it may compare the current manufacturing data with all abnormal rules in FIG. 5B, and identify that the current manufacturing data matches with the 5th classification rule (i.e., cold water pressure >65, argon pressure >105, casting powder type=A→D1), and belongs to the abnormal class “D1”.

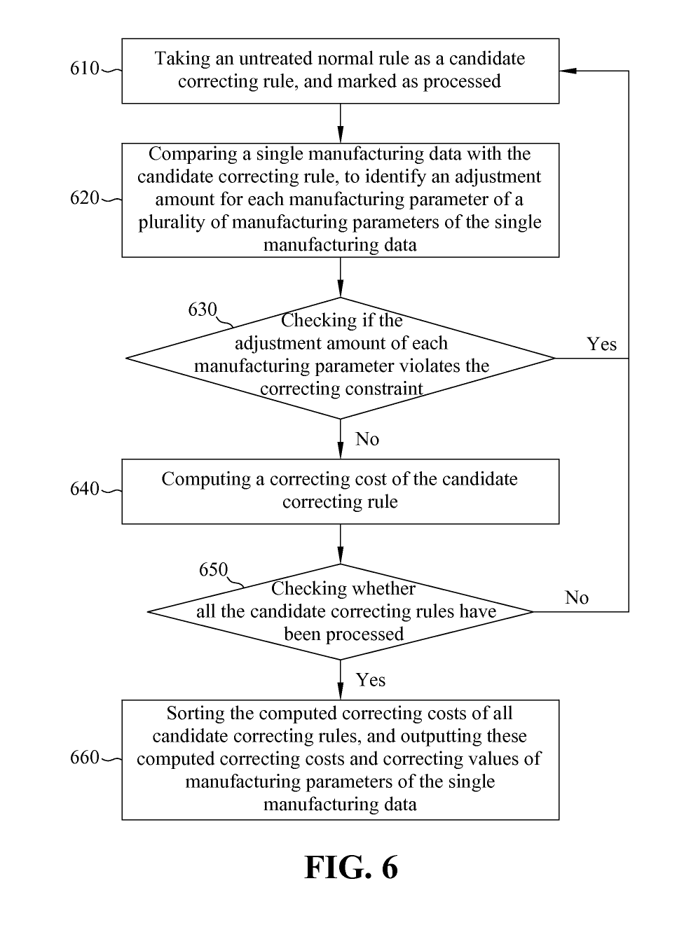

Following the exemplary embodiment of FIG. 5B, there are three normal rules in FIG. 5B (i.e., the quality code “N” in the second, fourth, and ninth classification rules, that is, a total of three candidate correcting rules). According to the step 330 in FIG. 3, it may compare the current manufacturing data with the three candidate correcting rules, decide a correcting rule, and one or more correcting values of at least one manufacturing parameter in this five manufacturing parameters of this current single manufacturing data. According to an exemplary embodiment of the present disclosure, it may determine the correcting rule by using an optimal correcting strategy selection method, which including: for each normal classification rule in the at least one normal classification rule not violating correcting constraints, calculating the needed cost of adjusting the current single manufacturing data to meet the normal classification rule, and selecting the normal classification rule with a smallest correcting cost from those calculated correcting costs as the correcting rule. FIG. 6 shows an operation flow illustrating an optimal selection method for correcting strategy, according to an exemplary embodiment of the disclosure.

Refer to the detail operation flow in FIG. 6, firstly, an untreated normal rule is taken as a candidate correcting rule, and then marked as processed (step 610); a single manufacturing data is compared with the candidate correcting rule, to identify an adjustment amount for each manufacturing parameter of a plurality of manufacturing parameters of the single manufacturing data (step 620); and check if the adjustment amount of each manufacturing parameter violates the correcting constraint (step 630). When violating the correcting constraints, returns to step 610; when no violating the correcting constraints, a correcting cost of the candidate correcting rule is computed (step 640), and whether all the candidate correcting rules have been processed is checked (step 650). When there is at least one correcting rule not yet been processed, returns to step 610; When all candidate correcting rules have been processed, the computed correcting costs of all candidate correcting rules are sorted, and these computed correcting costs and correcting values of manufacturing parameters of the single manufacturing data are outputted (step 660).

According to an exemplary embodiment of the disclosure, calculating the correcting costs of the candidate correcting rules to select a correcting rule may be determined by a support, a confidence level, and at least one correcting constraint of each of these candidate correcting rules. The support of a rule is defined as a number of data items in a plurality of historic manufacturing data matching the rule. The confidence of a rule is defined as a number of data items in a plurality historic manufacturing data matching the rule, divided by the number of data items in the plurality of historic manufacturing data matching the known condition of the rule. Assuming there are 100 data items in the historic manufacturing data library, a rule is “Rₖ: Aₖ→Cₖ,” in which 50 data items occur Aₖ, but 30 data items occur Aₖ and Cₖ, then the support of this rule is 30÷100=0.3, the confidence of this rule is 30÷50=0.6. In other words, the support of a rule reflects a representative of the rule; the confidence of a rule is a number of data items correctly presumed by the rule, divided by a number of data items matching the known condition of the rule. The confidence may reflect a speculated accuracy degree of the rule in the plurality of historic data.

In the abnormal rules of FIG. 5B, the rule of secondary cold water pressure >65, argon pressure >105, casting powder type=A→D1 is taken as an exemplar. The support of this rule is the number of data items in the historic manufacturing data satisfying secondary cold water pressure >65, argon pressure >105, casting powder type=A, and the quality code D1, divided by the number of data items in all historic manufacturing data. The confidence of the rule is number of data items in historic manufacturing data satisfying secondary cold water pressure >65, argon pressure >105, casting powder type=A, and the quality code D1, divided by the number of data items in the history of manufacturing data satisfying secondary cold pressure >65, argon pressure strength >105, casting powder type=A.

The continuous casting manufacturing in a steel mill is taken to illustrate an exemplar of the correcting constraint. In the continuous casting process, some abnormalities relate to the precipitation of chemical elements whereas the doctrinal increasing temperature of the straightening zone may reduce the precipitation of chemical elements. The analysis results may obtain a correcting strategy such as increasing the temperature of the straightening zone. However, increasing the straightening zone temperature in an actual manufacturing environment exceeds a certain limit may cause overheating and damage to the equipment in the manufacturing environment. Therefore, an upper temperature of the straightening zone should be limited. Limiting the upper limit of the temperature of the straightening zone is one exemplar of the correcting constraint. Another example is, in the continuous casting process, some abnormalities relate to the molten steel composition, the analysis results may obtain a correcting strategy such as adjusting the molten steel composition. However, this implies the need to re-refine the molten steel, the cost is very huge, or the molten steel compositions after adjustment may be lower than or exceeding the ingredient specifications that the customer requests. Therefore in the actual manufacturing environment, such an abnormal correction of adjusting the molten steel composition should be excluded; this is also a correcting constraint.

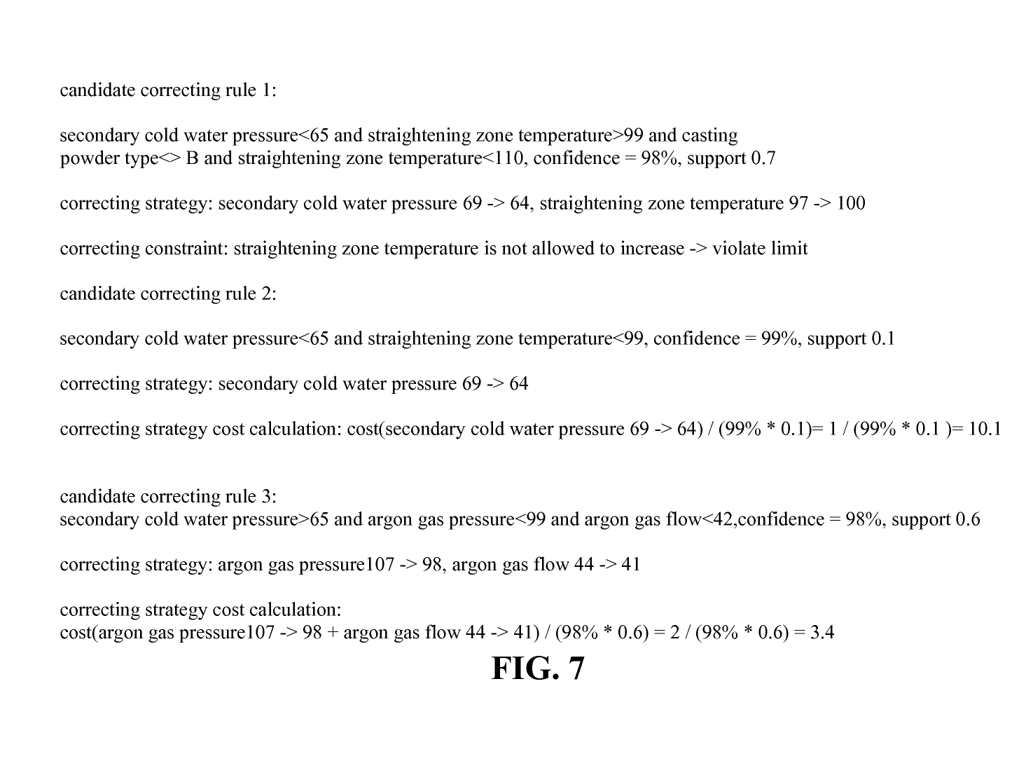

Take the classification rules of FIG. 5B as an example, assuming that the current manufacturing data comprises five manufacturing parameters, wherein for X_{k,1} (second cold water pressure)=69; X_{k,2} (argon gas pressure)=107; X_{k,3} (argon flow)=44; X_{k,4} (powders species)=A; X_{k,5} (straightening zone temperature)=97; the confidence of the candidate correcting rule 1 (i.e., the second classification rule) is 98%, and the support is 0.7; the confidence of candidate correcting rule 2 (i.e., the fourth classification rule) is 99%, and the support of is 0.1; the confidence of candidate correcting rule 3 (i.e., the ninth classification rule) is 98%, and the support is 0.6. For example, FIG. 7 shows correcting strategies and corresponding correcting constraints of candidate correcting rules, and the cost calculation of the correcting strategies, according to an exemplary embodiment of the disclosure. As shown in the exemplary embodiment of FIG. 7, for the candidate correcting rule 1, the correcting strategy is: secondary cold water pressure 69→64, straightening zone temperature 97→100; wherein “straightening zone temperature 97→100” violates the correcting constraint of “straightening zone temperature is not allowed to increase”. Therefore, the candidate correcting rule 1 will not be a decided correcting rule. For the candidate correcting rule 2, the correcting strategy is: secondary cold water pressure 69→64; the correcting strategy cost is 10.1. For the candidate correcting rule 3, the correcting strategy is: argon pressure 107→98, argon gas flow 44→41; the correcting strategy cost is 3.4. Therefore, the candidate correcting rule 3 will not violate the correcting constraint and has a minimum cost, thus becoming the decided correcting rule. According to the correcting rule for the current single manufacturing data, the correcting strategy for eliminating the abnormal is as follows: argon gas pressure is lowered to 98 or less, and the argon gas flow rate is lowered to 41 or less.

The correcting cost, for example, may be calculated based on the single manufacturing data, the correcting rule, and the adjust amount of each manufacturing parameter. Assuming that there are p parameters in a single manufacturing data X, according to the correcting rule Rₖ to perform the correction. The correcting cost may be expressed as the following formula:

$$Cost ( X , {R}_{k} ) = 1 / Support ( {R}_{k} ) \times 1 / Confidence ( {R}_{k} ) \times {\sum }_{j = 1}^{p} ( {Normalization}_{j} ( {A}_{j} ) \times {W}_{j} )$$

Wherein, Support (Rₖ), Confidence (Rₖ) and Normalizationⱼ are the support, the confidence of rule Rₖ, and the normalization function of the j-th manufacturing parameter, respectively. Aⱼ represents the necessary adjustment amount of the j-th manufacturing parameter Xⱼ in X according to the correcting rule, which may be obtained by matching Xⱼ and the correcting rule Rₖ:

Aⱼ=matching (Xⱼ,Rₖ),

where j=1˜p.

If Xⱼ does not need an adjustment, then Aⱼ is 0. Each manufacturing parameter is in different units, and the distribution range of each manufacturing parameter is also different, thus each manufacturing parameter needs to be adjusted to an amount of a normalized range from 0 to 1. For a numerical parameter Xⱼ, Z-score (Normalization) may be used for normalization, namely Normalizationⱼ(Aⱼ)=Z-score(Aⱼ); for a non-numerical parameter Xⱼ, no adjustment amount is needed, Normalizationⱼ(Aⱼ) is set to 1.

Because of different resources required for adjusting each abnormal manufacturing parameter, according to an exemplary embodiment of the present disclosure, the adjusting cost weight, i.e., Wⱼ of each manufacturing parameter Xⱼ may be further considered. If a necessary resource consumed for adjusting the manufacturing parameter Xⱼ is larger, then Wⱼ may be set higher. The design of weight needs to take required resources of correcting manufacturing parameters into consideration. After selecting the reference point, the weights may be set relatively at the beginning of the system, and may also be modified or increased by accumulating experiences, environment or product changes, etc.

Calculating methods for a correcting cost are not limited to the examples of FIG. 7. For example, in the exemplary decision tree, it may use the leaf node where the single manufacturing data located to calculate a path length of reaching the leaf node where the correcting rule located. It may also be the calculation method for the correcting cost of the correcting rule of the decision tree:

Cost (X,Rₖ)=distance (Decision_Tree_Node (X),Decision_Tree_Node (Rₖ)).

Wherein Decision_Tree_Node (X) represents the leaf node where the single manufacturing data X located, Decision_Tree_Node (Rₖ) represents the leaf node where the correcting rule Rₖ located.

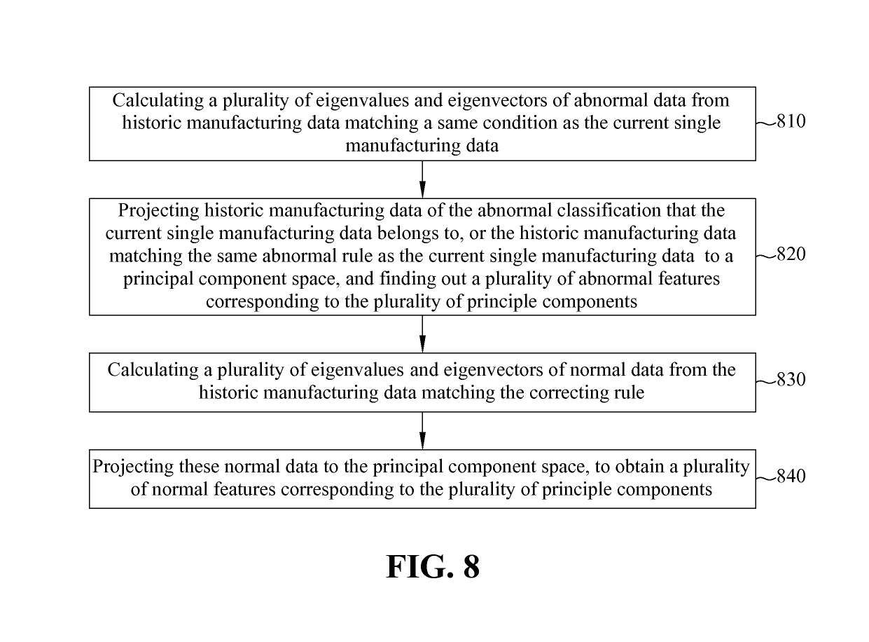

Based on the exemplary embodiments described above, in step 340, in accordance with the historic manufacturing data, the abnormal features of the abnormal classification that the current manufacturing data belongs to are extracted, and the normal features matching the normal rule are extracted. The bidirectional feature extraction method may use, but is not limited to a statistical analysis method. The statistical analysis method may be such as a principal component analysis (PCA) method, an independent component analysis method, a partial least squares method, etc. FIG. 8 shows a detailed operation flow of a bidirectional feature extraction method, according to exemplary embodiment of the disclosure. Refer to FIG. 8, the bidirectional feature extraction method calculates a plurality of eigenvalues and eigenvectors of abnormal data from historic manufacturing data matching a same condition as the current single manufacturing data (for example, the quality code D1 in the historic manufacturing data, or the historic manufacturing data matching the same abnormal rule as the current single manufacturing data) (step 810). When using the principal component analysis method, each eigenvector is a principal component, the corresponding eigenvalue is the weight of the principle component, to represent its importance. Then historic manufacturing data of the abnormal classification that the current single manufacturing data belongs to, or the historic manufacturing data matching the same abnormal rule as the current single manufacturing data are projected to a principal component space, and a plurality of abnormal features corresponding to the plurality of principle components are found out (step 820); and a plurality of eigenvalues and eigenvectors of normal data are calculated from the historic manufacturing data matching the correcting rule (step 830), then these normal data are projected to the principal component space, to obtain a plurality of normal features corresponding to the plurality of principle components (step 840).

According to exemplary embodiments of the present disclosure, steps 810 is required to be performed before step 820; and step 830 is required to be performed before step 840. The order from before to after for performing the four steps 810, 820, 830, 840 in this bidirectional feature extraction method is flexible. For example, according to an exemplary embodiment, an order from before to after for performing the four steps is step 810→step 820→step 830→step 840. According to another exemplary embodiment, the order from before to after for performing the four steps is step 830→step 840→step 810→step 820.

When using the principal component analysis method described above, for a principal component, a corresponding abnormal feature may be obtained by converting each of the abnormal data into a principal component score and then taking a weighted average of the principal component scores. Therefore, for a plurality of principal components, a plurality of the abnormal features representing the abnormal data described above may be obtained. These abnormal data are data matching the same conditions as the single manufacturing data, for example, the data having the same abnormal type as the single manufacturing data, or the data matching the same abnormal rule as the single manufacturing data. Similarly, when the normal data described above are projected to the principal component space, a plurality of normal features representing the above normal data may be obtained.

Take the abnormal rule of FIG. 5B as an exemplar. For secondary cold water pressure >65, argon pressure >105, and the casting powder type=A->D1, by projecting those historic manufacturing data with quality code D1 onto the principal component space, and by converting those historic manufacturing data into principal component scores and taking a weighted average, these weighted averages corresponding to a plurality of principal components become a plurality of abnormal features. In addition, the eigenvalues and eigenvectors representing those normal data are computed from the historic manufacturing data matching the correcting rule (i.e., historic manufacturing data with secondary cold water pressure >65, argon pressure <99, and argon flow <42), and then the historic manufacturing data are projected onto the principal component space, converted into principal component scores, followed by taking weighted average. These resulting weighted averages corresponding to a plurality of principal components become a plurality of normal features.

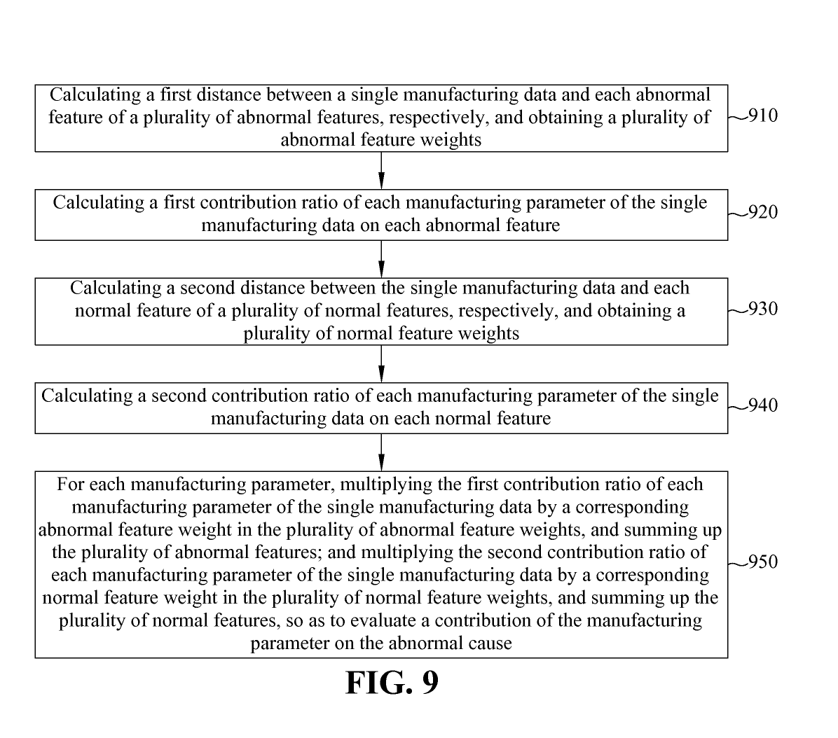

With these abnormal features and these normal features, FIG. 9 shows an operation flow for evaluating an abnormal cause contribution of a manufacturing parameter, according to the exemplary embodiment of the disclosure. Refer to the operation flow in FIG. 9, a first distance between a single manufacturing data and each abnormal feature of a plurality of abnormal features is calculated, respectively, and a plurality of abnormal feature weights are obtained (step 910); a first contribution ratio of each manufacturing parameter of the single manufacturing data on each abnormal feature is calculated (step 920); and a second distance between the single manufacturing data and each normal feature of a plurality of normal features is calculated, respectively, and a plurality of normal feature weights are obtained (step 930); a second contribution ratio of each manufacturing parameter of the single manufacturing data on each normal feature is calculated (step 940); and for each manufacturing parameter, the first contribution ratio of each manufacturing parameter of the single manufacturing data is multiplied by a corresponding abnormal feature weight in the plurality of abnormal feature weights, and the plurality of abnormal features are summed up; and the second contribution ratio of each manufacturing parameter of the single manufacturing data is multiplied by a corresponding normal feature weight in the plurality of normal feature weights, and the plurality of normal features are summed up, so as to evaluate a contribution of the manufacturing parameter on the abnormal cause (step 950).

According to the exemplary embodiments of the present disclosure, step 950 is required to be the final step in the five steps 910˜950. While the order from before to after for the four steps 910˜940 may be optionally swapped.

In step 910 and step 930, the calculating method for the first or second distance between the single manufacturing data and an abnormal or normal feature is required to couple the method of obtaining the abnormal or normal feature. For example, for an abnormal or normal feature obtained by the principle component analysis method, it requires to calculate the principle component score of the single manufacturing data on the corresponding principle component, this score is then subtracted by the abnormal or normal feature, and then divided by the corresponding eigenvalue of the principal component; this is the Mahalanobis distance algorithm. If the Euclidean distance algorithm is used, the principle component is not required to be divided by the corresponding eigenvalue. According to exemplary embodiments of the disclosure, calculating the distance between the single manufacturing data and an abnormal or normal feature is not limited to the Mahalanobis distance algorithm or the Euclidean distance algorithm. According to exemplary embodiments of the present disclosure, for a normal feature, the greater the distance the higher the weight obtained, this distance may therefore be used as a normal feature weight; for an abnormal feature, the smaller the distance the higher the weight obtained, the inverse of the distance may therefore be used as an abnormal feature weight.

In other words, according to exemplary embodiments of the present disclosure, evaluating the at least one abnormal cause contribution of a plurality of manufacturing parameters corresponding to the single manufacturing data in the step 350 further includes: using a distance algorithm to calculate the distance between the single manufacturing data and said each extracted abnormal feature, and calculate the distance between the single manufacturing data and said each extracted normal feature.

In step 920 and step 940, calculating the contribution ratio of each manufacturing parameter of the single manufacturing data on each abnormal or normal feature is required to couple the calculating method of abnormal/normal feature. For example, for an abnormal or normal feature obtained by the principle component analysis method, the loading of the principle component represents the contribution ratio of each manufacturing parameter on the abnormal or normal feature.

In other words, according to exemplary embodiments of the present disclosure, evaluating at least one abnormal cause contribution of the plurality of manufacturing parameters corresponding to the current single manufacturing data in the step 350 further includes: cooperating with a feature calculation method to calculate the contribution ratio of each manufacturing parameter of the single manufacturing data on said each extracted abnormal feature, and calculate the contribution ratio of each manufacturing parameter of the single manufacturing data on said each extracted normal feature.

Step 950 may be expresses by the following formula:

$$Contribution ( i ) = {\sum }_{j = 1}^{p} ( abnormal\_contribution {\_ r}_{i , j} \times {abnormal\_ w}_{j} ) + {\sum }_{j = 1}^{q} ( normal\_contribution {\_ r}_{i , j} \times {normal\_ w}_{j} )$$

wherein Contribution (i) represents the contribution of the i-th manufacturing parameter Xᵢ to the abnormal causes, p represents an abnormal feature number, abnormal_contribution_r_{i,j} represents the contribution ratio of the i-th manufacturing parameters Xᵢ on the j-th abnormal feature, abnormal_{—} wⱼ represents the j-th abnormal feature weight; q represents a normal feature number, normal_contribution_r_{i,j} represents the contribution ratio of the i-th manufacturing parameter Xᵢ on the j-th normal features, normal_wⱼ represents the j-th normal feature weight.

In other words, according to exemplary embodiments of the present disclosure, evaluating at least one abnormal cause contribution of a plurality of manufacturing parameters corresponding to the current single manufacturing data in the step 350 further includes: considering an abnormal feature weight of the single manufacturing data to said each extracted abnormal feature, and considering a normal feature weight of the single manufacturing data to said each extracted normal feature.

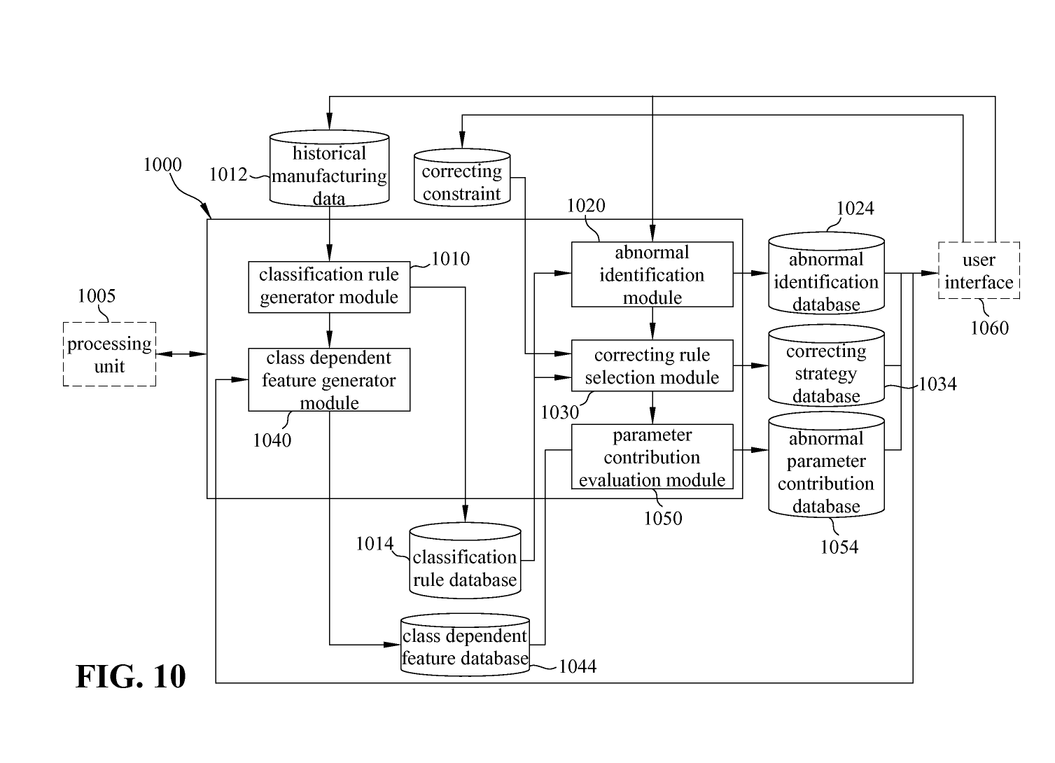

FIG. 10 shows a system of cause analysis and correction for manufacturing data, according to an exemplary embodiment of the disclosure. The system of cause analysis and correction for manufacturing data is adapted to a manufacturing process of a manufacturing system. Refer to FIG. 10, a system of cause analysis and correction for manufacturing data 1000 may include a classification rule generator module 1010, an abnormal identification module 1020, a correcting rule selection module 1030, a class dependent feature generator module 1040, and a parameter contribution evaluation module 1050. The classification rule generator module 1010 establishes, based on a plurality of historic manufacturing data, at least one abnormal classification rule and at least one normal classification rule. These established classification rules may be stored in a classification rule database 1014. The abnormal identification module 1020 compares a current single manufacturing data with the at least one abnormal classification rule to identify at least one abnormal rule matching the current single manufacturing data, and an abnormal class thereof. These identified abnormal rules and abnormal class may be stored in an abnormal identification database 1024 and transferred back to the user. The correcting rule selection module 1030 compares the current single manufacturing data with the at least one normal classification rule to generate a plurality of correcting strategies and determine a correcting rule, and determine one or more correcting values of at least one manufacturing parameter of the plurality of manufacturing parameters. These correcting strategies may be stored in a correcting strategy database 1034 and transferred back to the user. The class dependent feature generator module 1040 extracts a plurality of abnormal features from the plurality of historic manufacturing data having a same condition as that of the current single manufacturing data, and extracts a plurality of normal features from the plurality of historic manufacturing data matching the correcting rule. These abnormal features and normal features may be stored in a class dependent feature database 1044. The parameter contribution evaluation module 1050, based on the plurality of abnormal features and the plurality of normal features, evaluates at least one abnormal cause contribution of the plurality of manufacturing parameters corresponding to the current single manufacturing data. Each cause contribution of the plurality of manufacturing parameters corresponding to the single manufacturing data may be stored in an abnormal parameter contribution database 1054 and transferred back to the user.

The classification rule generator module 1010, or the abnormal identification module 1020, or the correcting rule selection module 1030, or the class dependent feature generator module 1040, or the parameter contribution evaluation module 1050 may use hardware description languages (such as Verilog or VHDL) to perform the circuit design, and to be burned to a field programmable gate array (FPGA) after integration and layout. The circuit design accomplished by the hardware description languages may be implemented, for example, by a professional manufacturer of integrated circuits to produce application-specific integrated circuits or called ASIC. In other words, the system of cause analysis and correction for manufacturing data 1000 may comprise at least one integrated circuit to implement the functions of the classification rule generator module 1010, the abnormal identification module 1020, the correcting rule selection module 1030, the class dependent feature generator module 1040, and the parameter contribution evaluation module 1050.

The system of cause analysis and correction for manufacturing data 1000 may also include at least one processing unit 1005 that implements the functions of the classification rule generator module 1010, the abnormal identification module 1020, the correcting rule selection module 1030, the class dependent feature generator module 1040, and the parameter contribution evaluation module 1050.

The established rules, the identified abnormal rules and abnormal classes, the correcting strategies, the abnormal features and normal features, and the contributions of the manufacturing parameters corresponding to the single manufacturing data may be stored in their corresponding databases, respectively, or may use a server database to store. The classification rules database 1014, the abnormal identification database 1024, the correcting strategy database 1034, the class dependent feature database 1044, and the abnormal cause parameter database 1054 may be established in at least one storage device.

According to another embodiment of the present disclosure, a plurality of historical manufacturing data 1012 and any manufacturing data may be provided to the system of cause analysis and correction for manufacturing data 1000 via a user interface 1060. The identified abnormal rules and the abnormal class, the correcting strategy, and the cause contribution may also be transferred back to one or more users via the user interface 1060. The system of cause analysis and correction for manufacturing data 1000 may be adapted to a manufacturing system, and the application scenarios is such as, but not limited to the example of FIG. 2. For example, the system of cause analysis and correction for manufacturing data 1000 may also be a server.

In summary, according to the exemplary embodiments of the present disclosure, a method and a system of cause analysis and correction for manufacturing data are provided. The technique comprises, based on historic manufacturing data, establishing abnormal classification rules and normal classification rules; comparing a manufacturing data with the abnormal classification rules to identify abnormal rules matching the manufacturing data and an abnormal class thereof, comparing a manufacturing data with the normal classification rules to determine a correcting rule and suggest correcting values of the manufacturing parameters of the manufacturing data; and extracting abnormal features from the historic manufacturing data having the same condition as that of the manufacturing data, and extracting normal features from the historic manufacturing data matching the correcting rule; and based on the abnormal features and the normal features, evaluating the cause contributions of the plurality of manufacturing parameters corresponding to the manufacturing data. According to the exemplary embodiments of the present disclosure, this technique may analyze abnormal causes and correcting methods for each single manufacturing data, use the current abnormal cause analysis, to assist abnormal correction and strategy assistance so as to rapidly correct the manufacturing abnormalities on the manufacturing site. This technique may analyze many types of parameter data (including such as numerical and/or non-numerical data), integrate a bidirectional contribution evaluation of normal and abnormal data to assist the analysis of abnormal root causes on the manufacturing site.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method of cause analysis and correction for manufacturing data, adapted to a manufacturing process in a manufacturing system, comprising:
based on a plurality of historic manufacturing data, establishing at least one abnormal classification rule and at least one normal classification rule, and storing the at least one abnormal classification rule and the at least one normal classification rule in a database storage device;
comparing a current single manufacturing data with the at least one abnormal classification rule to identify at least one abnormal rule matching the current single manufacturing data and an abnormal class thereof, wherein the current single manufacturing data comprises a plurality of manufacturing parameters;
comparing the current single manufacturing data with the at least one normal classification rule to determine a correcting rule, and determine one or more correcting values of at least one manufacturing parameter of the plurality of manufacturing parameters;
extracting a plurality of abnormal features from the plurality of historic manufacturing data having a same condition as that of the current single manufacturing data, and extracting a plurality of normal features from the plurality of historic manufacturing data matching the correcting rule; and
based on the plurality of abnormal features and the plurality of normal features, evaluating at least one abnormal cause contribution of the plurality of manufacturing parameters corresponding to the current single manufacturing data.

2. The method as claimed in claim 1, wherein said plurality of historic manufacturing data and said current single manufacturing data comprise one or more manufacturing parameters and a quality code recorded for a product in a manufacturing process.

3. The method as claimed in claim 2, wherein said quality code is a quality level, or one of a plurality of abnormal classes, or a normal class that represents no abnormality.

4. The method as claimed in claim 2, wherein said plurality of manufacturing parameters of said current single manufacturing data comprise one or more setting values or control values for one or more manufacturing conditions in said manufacturing process.

5. The method as claimed in claim 2, wherein said plurality of manufacturing parameters of said manufacturing data comprise one or more measured values or sensed values of one or more measuring devices set in a manufacturing field of said manufacturing process.

6. The method as claimed in claim 1, wherein said same condition is a same quality code, or matching a same abnormal rule.

7. The method as claimed in claim 1, wherein determining said correcting rule further includes:
for each normal classification rule in the at least one normal classification rule not violating correcting constraints, calculating a needed correcting cost of adjusting the current single manufacturing data to meet the normal classification rule, and selecting the normal classification rule with a smallest correcting cost from those calculated correcting costs as the correcting rule.

8. The method as claimed in claim 7, wherein calculating said needed correcting cost to meet said normal classification rule is determined by a support and a confidence of said normal classification rule.

9. The method as claimed in claim 8, wherein calculating said needed correcting cost to meet said normal classification rule further includes:
based on an adjustment value of each manufacturing parameter of said plurality of manufacturing parameters of said current single manufacturing data and an adjustment cost weight corresponding to said each manufacturing parameter, calculating said needed correcting cost.

10. The method as claimed in claim 1, wherein said method uses a decision tree algorithm to establish said at least one abnormal classification rule and said at least one normal classification rule, wherein a path from a root node to a leaf node of a decision tree represents a classification rule.

11. The method as claimed in claim 10, wherein calculating a correcting cost to meet said normal classification rule is using a first leaf node of said decision tree of said current single manufacturing data to calculate a path length of reaching a second leaf node where said correcting rule located of said decision tree.

12. The method as claimed in claim 1, wherein said method uses a statistical analysis method to calculate a plurality of eigenvalues and eigenvectors representing abnormal data from said historic manufacturing data matching a same condition as said current single manufacturing data, and calculate a plurality of eigenvalues and eigenvectors representing normal data from said historic manufacturing data matching said correcting rule.

13. The method as claimed in claim 1, wherein evaluating the at least one abnormal cause contribution of said plurality of manufacturing parameters corresponding to said current single manufacturing data further includes:
calculating a first distance between said current single manufacturing data and each abnormal feature of said plurality of abnormal features and calculating a second distance between said current single manufacturing data and each normal feature of said plurality of normal features, by using a distance algorithm.

14. The method as claimed in claim 13, wherein evaluating the at least one abnormal cause contribution of said plurality of manufacturing parameters corresponding to said current single manufacturing data further includes:
coupled with a feature calculation algorithm, for each manufacturing parameter of said single manufacturing data, calculating a first contribution ratio on said each abnormal feature in said plurality of abnormal feature, and calculating a second contribution ratio on said each normal feature in said plurality of normal feature; and
considering an abnormal feature weight of said each abnormal feature and a normal feature weight of said each normal feature.

15. A system of cause analysis and correction for manufacturing data, adapted to a manufacturing process in a manufacturing system, and comprising:
a classification rule generator module that establishes, based on a plurality of historic manufacturing data, at least one abnormal classification rule and at least one normal classification rule;
an abnormal identification module that compares a manufacturing data with said at least one abnormal classification rule to identify at least one abnormal rule matching said manufacturing data and an abnormal class thereof;
a correcting rule selection module that compares the manufacturing data with the at least one normal classification rule to generate a plurality of correcting strategies and determine a correcting rule, and determine one or more correcting values of at least one manufacturing parameter of a plurality of manufacturing parameters;
a class dependent feature generator module that extracts a plurality of abnormal features from the plurality of historic manufacturing data having a same condition as that of the manufacturing data, and extracts a plurality of normal features from the plurality of historic manufacturing data matching the correcting rule; and
a parameter contribution evaluation module that evaluates, based on the plurality of abnormal features and the plurality of normal features, at least one abnormal cause contribution of the plurality of manufacturing parameters corresponding to the manufacturing data.

16. The system of cause analysis and correction as claimed in claim 15, wherein said classification rule generator module, said abnormal identification module, said correcting rule selection module, said class dependent feature generator module, and said parameter contribution evaluation module are implemented by at least one integrated circuit.

17. The system of cause analysis and correction as claimed in claim 15, wherein said system of cause analysis and correction includes at least one processing unit that implements a plurality of functions of the classification rule generator module, the abnormal identification module, the correcting rule selection module, the class dependent feature generator module, and the parameter contribution evaluation module.

18. The system of cause analysis and correction as claimed in claim 15, wherein said plurality of historic manufacturing data and said manufacturing data are provided, via a user interface, to said system of cause analysis and correction, while said identified abnormal rules and said abnormal class, said plurality of correcting strategies, and said at least one abnormal cause contribution are transferred back to one or more users via said user interface.

19. The system of cause analysis and correction as claimed in claim 15, wherein each of said plurality of historic manufacturing data and said manufacturing data includes one or more corresponding manufacturing parameters and a quality code recorded for a product in a manufacturing process.

20. The system of cause analysis and correction as claimed in claim 19, wherein said quality code is a quality level, or one abnormal class of a plurality of abnormal classes, or a normal class representing no abnormality.
